(19) United States
(12) Patent Application Publication
(10) Pub. No.: US 2008/0289011 A1
(43) Pub. Date: Nov. 20, 2008

(54) Dualistic Microprocessor System for Purpose of Controlling Personal Computer Internet Communication Resource

(75) Inventors: Bridget Willoughby, Orlando, FL (US); William Pippin, Orlando, FL (US)

Correspondence Address: Bridget Willoughby, 1344 W. Colonial Drive, Orlando, FL, 32804, US

(73) Assignee: Bridget Willoughby, Orlando, FL (US)

(21) Appl. No.: 12/121,725

(22) Filed: May 15, 2008

Related U.S. Application Data
(60) Provisional application No. 60/938,368, filed on May 16, 2007.

(51) Int. Cl. G06F 7/04

(52) U.S. Cl. 726/4

(57) ABSTRACT

A system comprising of both software on a target computer and software residing on a removable hardware device, (currently embodiment is a USB device) designed for the sole purpose of limiting and or controlling Internet (IP based network) communications, based upon the presence of the external device. The system utilizes a unique device descriptor along with a unique stored identifier of the Physical Control Node (PCN) for the purposes of enabling the target computer to discriminate devices. A unique identifier held within the computer allows the PCN to discriminate the target computer. Furthermore, allowed IP addresses are stored in the PCN and or computer for the purpose of allowing access to specific IP addresses while connected. Tertiary criteria can be stored within the PCN and or computer for the purposes of further defining system behavior i.e. calendar and time restricted behavior, while logging associated events.

This application claims benefit of the provisional application No. 60/938,368 and filed on May 16, 2007. (Previously titled: System and Method for Controlling Access to Internet)

### TITLE OF THE INVENTION

Dualistic microprocessor system for purpose of controlling Personal Computer Internet communication resource

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

(a) Field of the Invention

The invention relates generally to the IP based communication system often associated with the use of a personal computer system. In addition personal computer systems often utilize Universal Serial Bus (USB) electrically connected devices. Specifically, a software system is proposed to use the presence of such USB connected devices to control the availability and functioning of the IP communications system of said personal computer system.

(b) Description of Related Art

Within the current technical climate the abilities of personal computers and their ability to use and explore the Internet via IP based communication resources, there has arisen the problem of individuals (in particular children) utilizing aspects of the Internet that are deemed undesirable by the personal computer owner or parent. The desire to control access to the Internet or specific IP addresses accessible over the connected communications resource has increased. With this additional need for control on Internet access, a need to allow the other functions of the personal computer to occur unrestrained is also evident. A method of allowing this selective control is deemed necessary.

Furthermore, many programs exist which filter content and restrict Internet connections. These systems, in general, make little distinction between the various users of the particular personal computer. Also, the ease of use and configurations of such products has shown to be more difficult for certain users. Our invention seeks to address and reduce these issues and complexities by offering a system, which, in its base configuration, will perform much like a switch and thereby reducing the complexity greatly.

With the above issue being known, a system by which this control can be accomplished had to be developed. It is well known that there are many security systems that can allow access or deny such to computer resources. However, the selective nature as described above is generally not present. Many software systems exist that filter language and known Internet addresses with content deemed offensive. These software systems tend to either be expensive, complicated, or a combination of both. To make the system able to protect such resources more simplistic, a physical method of storing and setting aspects of the system is considered. Today's personal computers almost universally support the use of USB based devices. Furthermore, to keep installation simplistic, the installation process must be devised as simplistic as possible. To this end, the use of USB devices that utilize the Human Interface Device (HID) protocol is preferred.

At this point we have 2 aspects in general terms. The first is a computer software application that can arbitrarily control the IP resources of a personal computer. The second is an external USB based device that contains information used by the proposed software application. The above 2 aspects give us the ability to control aspects in general terms. 2 other features are minimally desired. The first is the ability to uniquely identify the personal computer and the USB device. The second feature is the ability to define what Internet resources are allowed for access. The list of allowed IP resources is viewed as much smaller than those disallowed. Since it is presumed that a parent will be restricting the use of and availability of Internet resources for a child, this scheme of allowing IP sites is viewed a better solution than disallowing known unapproved sites. The second reason why an allowed list feature is preferred is that technology related to this type of software has shown that content filtering and context sensitive language filtering has proved to be a daunting technical as well as logical challenge. The design is a simplistic system as is deemed possible in today's technology to address the above issues. The only complexity is a hierarchical user level and time/calendar based limitations. These fall in the main examples of defining an Administrator [parent] controlled system and an alternate user [child] account type. Relative to time features, the need to limit duration of use of stated Internet resource is seen necessary. Calendar restrictions are seen necessary to limit the use of Internet resources to predetermined events, such as week days or even limiting the usage of resources to certain hours of the day if so chosen by the parent/administrator.

### SUMMARY OF THE INVENTION

According to the principals of the invention, a schema consisting of both software and hardware elements are combined to allow for the arbitrary access to the Internet communications resources of a computer in which the invention software and hardware elements are associated, without restricting access to any other resources of the associated computer. In accordance with the principals of the invention the software elements of this invention reside in two distinct physical locations, the first is on the target computer (or host) and the second resides in a more transportable form factor which is arbitrarily intermittently connected via USB communications resources to said host computer. In accordance with the principals of the invention, electronic data is exchanged between the two software processes in order to facilitate mutual authentication and behavioral rule exchange relative to controlled communications resources and subsequently in accordance with the principals of this invention determine the necessary state of said Internet communications resources. Furthermore in accordance with the principals of the invention, event logging and useful information is provided to the user of the host computer as deemed necessary by the principals of the invention and by the individual utilizing the host computer.

### BRIEF DESCRIPTION OF THE DRAWINGS

A more complete understanding of the present invention may be obtained from consideration of the following detailed description of the invention in conjunction with the drawing, with like elements referenced with like reference numerals in which:

FIG. 1 is a block diagram that shows the complete system proposed and its elements that exist on and in electrical proximity to a personal computer utilizing the described invention.

FIG. 2 is a flow diagram depicting the logic and functionality of the software devising the service application of the proposed invention.

FIG. 3 is a flow diagram depicting the logic and functionality of the software devising the portion of the service application responsible for the control of the IP based communications resources of the proposed invention.

FIG. 4 is a flow diagram depicting the logic and functionality of the software devising the portion of the service application responsible for the detection and communications with the USB connected HID protocol device named by this invention as the Physical Control Node (PCN).

FIG. 5 is a flow diagram depicting the logic and functionality of the software residing within the PCN portion of the invention.

FIG. 6 is a flow diagram depicting the generalized logic and functionality of the software residing on the PC and how it relates to allowing IP communication to propagate.

### DETAILED DESCRIPTION OF THE INVENTION

In the following description, for purposes of explanation and not limitation, specific details are set forth, such as particular components, interfaces, techniques, etc., in order to provide a thorough description of the present invention. However, it will be apparent to one skilled in the art that the present invention may be practical in other embodiments that depart from these specific details. In other instances, detailed descriptions of well-known methods, algorithms and programming procedures are omitted so as not to obscure the description of the present invention with unnecessary detail.

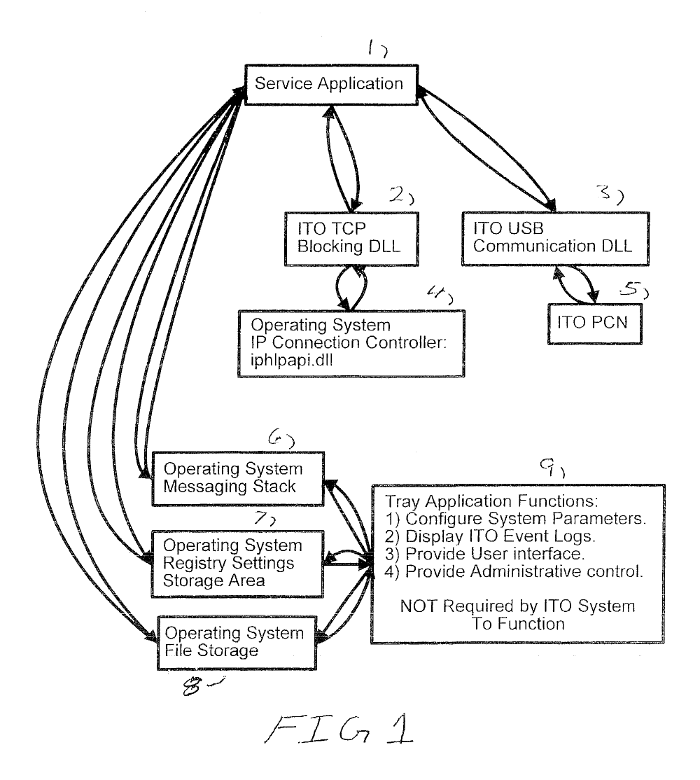

In order to implement the invention described several software and hardware items must be present. FIG. 1 illustrates the upper level generic aspects of the system proposed. The primary component of the system is the service application 1 and resides on the target PC. The target PC is the personal computer type system employing the System software that requires the PCN device to enable or disable functionality. A target PC is not limited to a personal computer. Target PC is being used as a generic term for any microprocessor based system that can communicate with a PCN unit. It is responsible for storing and loading service application configurations from the operating system registry 7. The service also sends and received operating system messages from the operating system's messaging stack 6. The service also logs appropriate data to the operating file system 8. The service application utilizes the ITO USB Communications DLL 3 to control, detect and communicate with the ITO PCN 5. When required by settings and state variables the service Application loads and unloads the ITO TCP Blocking DLL 2, which subsequently controls the Operating System IP Connection Controller DLL named iphlpapi.dll 4. This concludes the required aspects of the Service Application defined by the invention. The non-required portion of the system consists of the stand-alone Tray application 9. This portion of the system is designed to modify and display messages received via the operating system messaging stack 6 and data stored on the operating system's file storage area 8, in addition this application can configure all settings used by the Service application 1 and other required components.

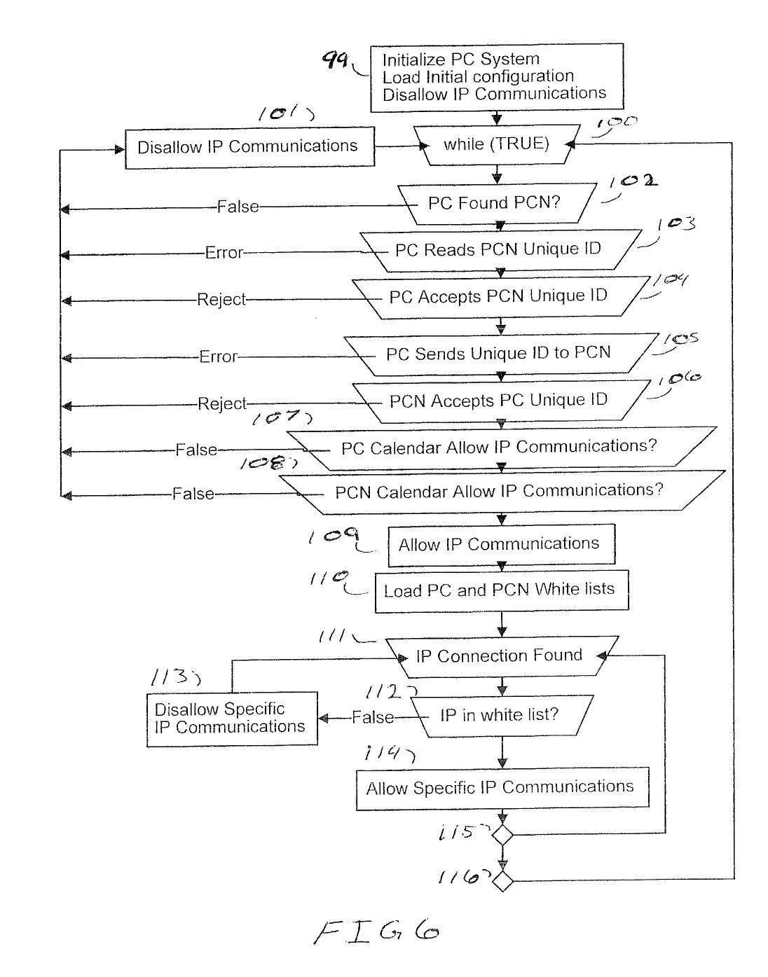

The software functionality of the system presented by this invention is summarized in FIG. 6. Upon program entry of the Service Application loads initial configuration settings and initializes related variables and states 99, IP communication is blocked by default. The system then enters the program loop starting with figure element 100 and ends with figure element 116. The first step in the system's logic is to determine if a PCN is connected via the USB communication DLL to the PC 102. If no PCN is found the program flow continues, disallowing IP communications via functionality of ITO TCP Blocking DLL (FIG. 1, element 2) 101 back to the service program loop entry 100. If a PCN is electrically coupled with the PC 102, the program then attempts to read the PCN unique identifier 103. If a failure occurs at this point, program flow control contuse thru element 101, if successful, the PC then applies programmed logic to determine if the electrically coupled PCN is recognized and subsequently allowed 104 by the PC service system of this invention. On error program flows thru element 101, on success program flow continues to the point where the PC service software presents the Service unique identifier to the electrically coupled PCN 105. On error program flow continues thru element 101, on success the Service application proceeds to read the PCN's response indicating acceptance 106 or rejection of the presented service unique identifier. On failure, program flow continues thru element 101, on success program flows to element 107 where PC service application calendar events and scheduling rules are queried. If service application rules relative to calendar events reject IP communications access program flows thru element 101. On success PCN calendar events are queried 108 in a similar fashion from either direct. communication with the electrically coupled PCN or via information stored provided by the connected PCN. If the rules associated with PCN calendar behavior reject IP communication program flows thru element 101. Program flow otherwise flows to element 109 where state variables allowing IP communications are set and the IP traffic is allowed via control of system element named ITO TCP Blocking DLL (FIG. 1, element 2). Depending on the service application configuration settings the service application then loads the IP address white lists of the PC and PCN 110. White Lists consist of values/quantities that are allowed to be utilized in some manner. In this example, there are 6 types. Allowed IP addresses White List, addresses are White listed IP addresses of websites that a PCN or Target PC will allow a system to connect to. Friendly targets White List. Friendly PCNs, the list of PCNs that a Target PC maintains that are allowed to use the system with appropriate security rights. (Claim 2). Friendly Admin PCNs White List is the list of Administrative level PCNs that are accepted within a Target PC. Or, can also refer to PCNs that are accepted for security purposes by user level PCNs. Friendly User PCNs White List is the list of user PCNs that can be accepted by a target system provided the appropriate security rights are applied. Also, applies to the list of user PCNs that can be acted upon by an Admin level PCN. Calendar White List, a list of time ranges (date or time) that that can be considered as part of the security logic hierarchy to enable or disable functionality of section 1. These calendar events indicate time and date ranges when a PCN is allowed to be utilized. Friendly Targets White List is the list of target PC systems that are White listed within a PCN. Flow control then proceeds to the loop beginning with element 111 and ending with element 115. As the service application detects active IP connections that IP connection is compared with the white list rules 112. As a note, if the white list feature is not used, all IP addresses are allowed and software progress proceeds thru element 114. If an IP address is not found within the white lists program flow continues thru element 113 where the specific IP connection is rejected and forcibly closed by the ITO TCP Blocking DLL (FIG. 1, element 2).

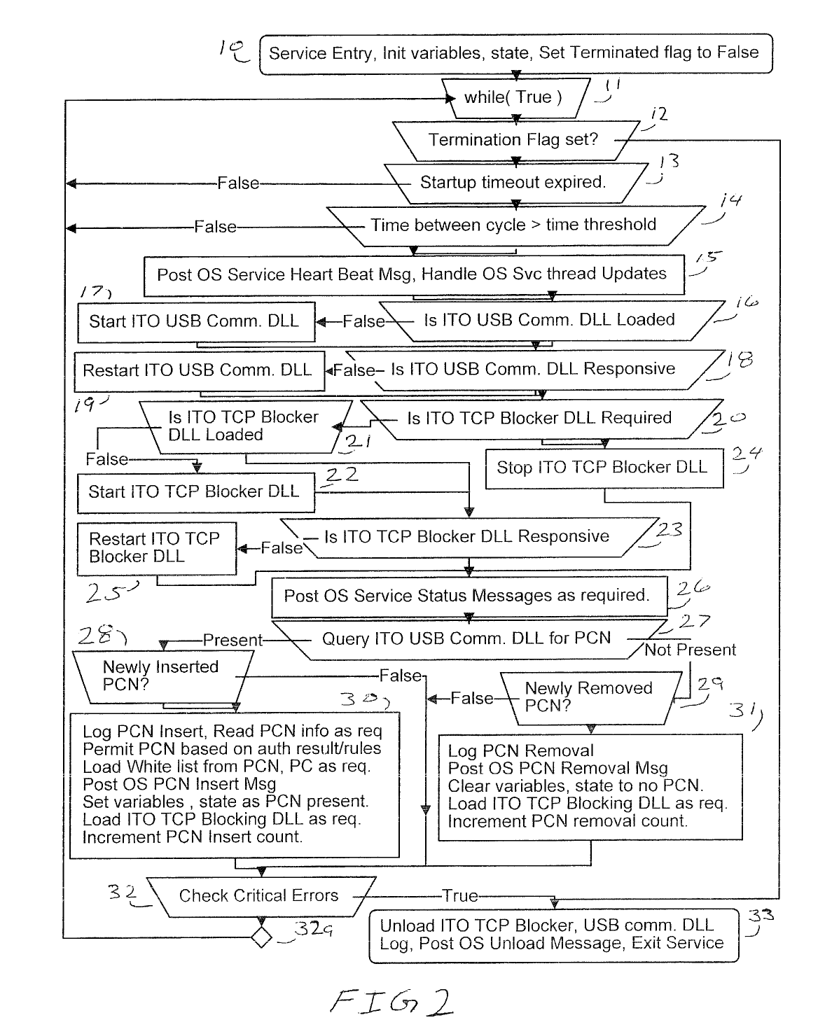

Preceding to specific software functionality of the key components of the invention we first review the flow diagram of the PC Service application as represented by FIG. 2 and general relations depicted in FIG. 1 as element 1. The PC Service application starts by initializing system variables, state variables 10 and acquiring the appropriate operating system permission and resources to perform the tasks defined. Program flow control continues to the loop starting with element 11 and ending with element 32a. The first activity within the program loop is to check the process termination flag 12. If this flag is true the program loop started at element 11 is exited and program flows thru element 33, which unloads resources, logs the appropriate messages and transmits the appropriate operating system messages to reflect the program termination. The Service termination variable can be set by the operating system and/or by the Tray application indicated by element 9 of FIG. 1. If the termination flag is not set 12 the program flow continues to element 13 where the service startup timer variable is verified. This startup timeout period is to allow the operating system necessary processing time to allow for trouble free program progression to element 14. If the startup time has not passed, flow control continues to service loop entry 11. In order for the service application to not demand too much CPU processing time from the PC operating system, a cycle duration variable is set and checked. If enough time has passed program flow continues to element 15, otherwise program flow continues to element 11. The service application loop posts messages to the operating system indicating that the service loop is active as well as handles operating system housekeeping functionality. Program flow progresses to element 16 where as needed, the ITO USB communications DLL is loaded 17 by the service application. Program flow continues and validates that the ITO USB communications DLL is responsive to commands 18. This is crucial in order to detect and handle errors related to the behavior of the Personal Computer's USB communications system and thus allowing for a stable overall system as presented by this invention. If the ITO USB Communications DLL is not responsive, the ITO USB communications DLL is restarted 19. Program flow continues and the requirement for the ITO TCP Blocking DLL functionality is determined 20. If needed the ITO TCB Blocking DLL's status is checked 21 and if determined to be needed and not present the ITO TCP Blocker DLL is started 22. At this point the ITO TCP Blocker DLL is checked for command responsiveness 23 and the ITO TCP Blocking DLL is restarted if errors are encountered 25. Readdressing element 20, if the ITO TCP Blocker DLL is not required, it is unloaded as need be at element 24. Program flow then continues to element 26 where Operating System messages are posted as need be to reflect useful state and error messages. Program flow continues to element 27 where the presence of an electrically coupled PCN via the ITO USB communications DLL is determined. If the previous PCN connection state was false and has just transitioned to true the state of a newly inserted PCN is detected 28. When this occurs, the service logs the PCN insertion, reads data, authenticates, and sets the parameters necessary to allow of block TCP connections considering all applicable rules and state variables 30. If the previous PCN connection state was true and has just transitioned to false the state of a newly removed PCN is detected 29. At this point the removal of the PCN is logged, related operating system messages sent and all state variables are set to the non-connected state as well as all TCP connections are blocked in accordance with configuration and state related factors 31. Program flow continues to element 32 where critical errors are detected and if present program flow control continues to element 33 otherwise program flow control continues to element 32a and subsequently on to the beginning of the service control loop 11.

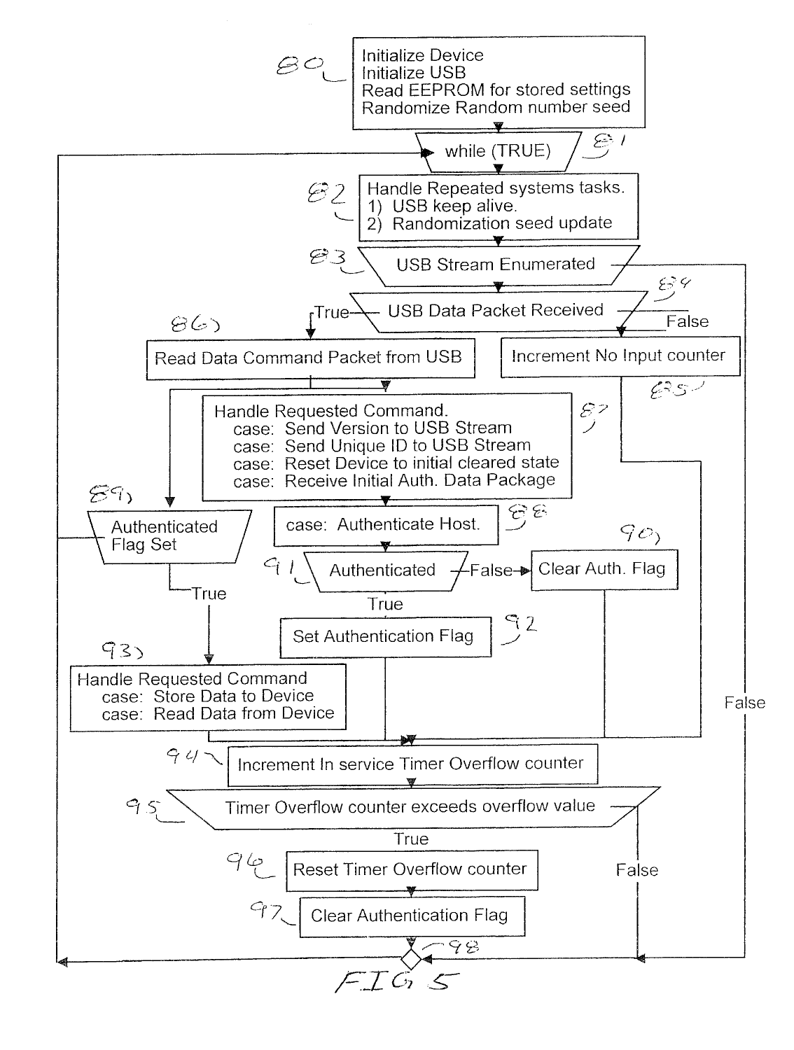

In further defining the system described by the invention a more detailed look into the program of the PCN is shown within FIG. 5. Physical Control Node (PCN) is the portable physical storage device used in our system. Currently it is embodied by a H.I.D. Protocol based USB device similar in physical dimension to the usual USB memory stick. The Software entry point 80 initializes variables and device states from data stored within non-volatile EEPROM memory as well as initializes the USB communications resources of the device upon application of power. After program initialization program flow continues to the main loop of the program that begins at element 81 and terminates with element 98. The first activity of the loop is to handle housekeeping 82 of the PCN resources such as addressing the USB communication system needs and updating the PCN's random number generator seed variables. The program flow continues to element 83 where the enumeration state of the USB communication system is queried. If the USB resources are not within the enumerated state program flow jumps to the beginning of the program loop 81 by way of element 98. After USB enumeration is verified program flow continues and the presence of inbound data on the USB communications resource channel is queried 84. If no inbound data is found program flow continues to element 85 where the no input count is incremented and subsequently on to element 94 which increments the program service Timer Overflow counter. Both counters are used by the PCN to adjust operating states to promote security and to help keep the PCN from experiencing lockup conditions. Program flow control continues to element 95 where the Timer Overflow counter is checked against a preset value. If this value is not exceeded program flow continues to element 81 via element 98. If the Timeout Overflow value does exceed the preset value the program flow continues by resetting the Timer Overflow Counter 96 and then clears the authenticated state flag 97 and other related variables. Program flow then continues at element 81 via element 98. Continuing our discussion at element 85, in the case a data packet is present on the USB communications resource that data packet is read 86 and the command is decoded from the data packet. Some commands can be processed at anytime regardless of the PCN's internal authentication state. These commands are briefly shown in element 87. If the authenticated state is satisfied, the secure read and write commands are allowed 93, otherwise program execution is continued at element 81. Element 88 depicts the case in which the Authenticate host command is received. The authentication process is verified 91, on failure the PCN Authentication Flag is cleared 90, on success the Authentication Flag is set 92. After PCN command processing program flow continues with element 94.

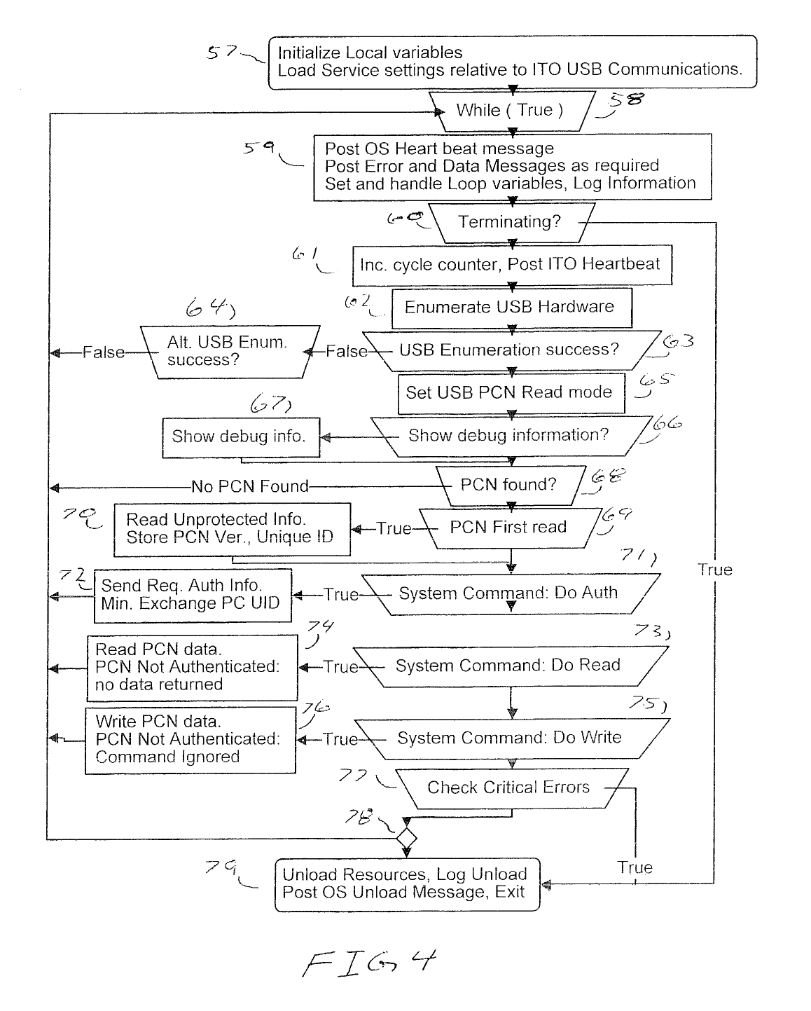

In more specific discussion the ITO USB Communications DLL will be addressed FIG. 4. The defined purpose of this DLL (Dynamically Linked Library) is to create and control the communications layer electrically coupling the Target PC to the PCN via the Target Personal Computer's USB communications resources. This DLL also facilitates the transport of data to and from the PCN and the PC in a logical fashion which includes direct access or buffered reads and writes as determined necessary to promote best fit performance of the Target PC and to transport such data in a manner in which the PCN can cope with due to the generally reduced central processing speed as compared to that available on the Target PC. The ITO USB Communications DLL (FIG. 1, element 3) is loaded by the Service Application (FIG. 1, element 1) and upon Initialization local variables and setting are stored and behavior adjusted based on these settings 57. Program flow then continues with the program loop starting at element 58 and ending with element 78. This program loop is exited upon 2 conditions. The first is that the DLL's internal terminating state variable 60 is set by internal or external means, or a critical 77 error occurs that is programmatically determined to require the exit from the loop. In this case program flow continues at element 79 where local resources are released, appropriate operating system messages posted, event logging occurs and DLL exit finally occurs. On entry of the main program loop 59, Operating system messages indicating the DLL's activity are sent along with messages indicating changes in internal state variables as well as errors, event logging to the operating systems' file system is accomplished and loop variables adjusted as need be. Program flow continues by checking the loop termination flag 60, as described earlier, and on to loop variable housekeeping entailing the incrementing of the cycle counter and an operating system message being posted to show activity 61. Program flow continues and the USB Hardware of the target PC is enumerated 62. If no hardware is located or an error occurs 63 an alternate means of querying USB resources is employed 64 thru the Operating System Registry. If an error occurs the program execution continues at element 58 with appropriate state variables set as to be reported in element 59 on the next iteration thru the program loop. Upon successful USB resource determination program flow continues at element 65 where the preferred mode of querying USB resources is set in order to speed the program time thru elements 63 and 64 on the next entrance into the program loop. AT this point, the DLL can display testing and debug information 67 if the program settings are configured to do so 66. Elements 66 and 67 are not necessary for normal operation but serve to help locate communications issues should they occur. Program execution continues by checking for an electrical connection between the Target PC and a PCN 68. If no PCN is found program variables and states are set accordingly and execution continues at the beginning of the program loop 58. If a PCN is detected the state variable are checked and if determined that this is new connection 69 program execution continues to element 70 where depending on settings all unsecure data is read and buffered as programmatically deemed necessary. Based on system state variables and received commands the program continues to element 71 where PC to PCN authentication is determined necessary. If deemed necessary the necessary authentication process 72 occurs, on failure or success program execution continues at element 58 with appropriate state and message variables set. Program flow continues to determine if data reads 73 or data writes 75 need to be handled. If reads are necessary program flow continues thru element 74 for reads or thru element 76 for writes depending on the appropriate Authentication state variables as well as system configuration needs. Program flow continues by checking for critical system errors 77 on to the beginning of the program loop 58 via element 78 if there are no critical errors or to DLL unload via element 79 if there are critical errors present.

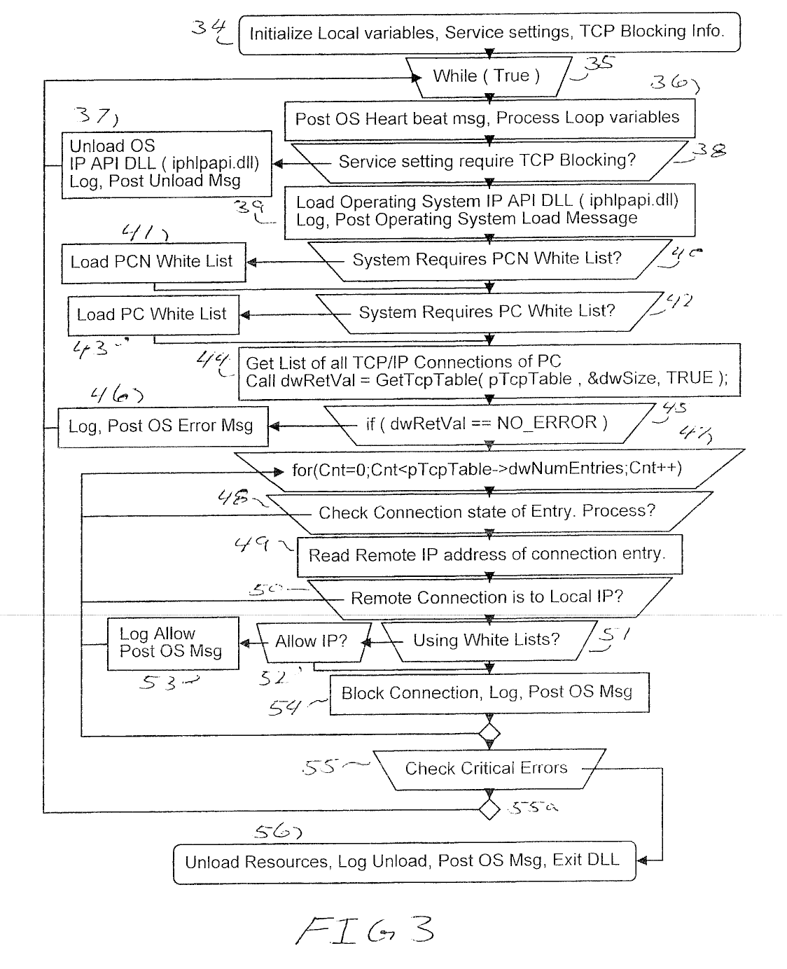

The detailed flow diagram of the ITO TCP Blocker DLL is shown within FIG. 3. The ITO TCP Blocker DLL is generally represented as part of the system described in this invention by element 2 of FIG. 1. The Service Application (FIG. 1, element 1) loads and unloads the ITO TCP Blocking DLL, as it programmatically deems necessary to satisfy program state and variable functionality related to the functions and behavior of the ITO TCP Blocking DLL. Program initialization of the ITO TCP Blocking DLL 34 consists of initializing local variables and state flags. The main program loop 35 is then entered and terminates at element 55a. This program loop is only exited in 2 conditions. The first is that the Service Application (FIG. 1, element 1) releases the resources and forcibly closes the DLL or if a critical error occurs 55 and program execution continues at element 56 where resources are released, necessary messages posted, events are logged and program flow continues to the DLL's termination. Upon loop entry appropriate messages are posted and events logged based on state variables 36 held within the ITO TCP Blocking DLL. After which the need for TCP communications to be blocked is determined 38. If resources do not need to be blocked appropriate state variables are posted, logged and set 37. In addition the Operating System resources responsible for controlling the TCP connection are released, namely iphlpapi.dll (FIG. 1, element 4). If the need for blocking TCP resources is valid, the resources for doing so are loaded (namely iphlpapi.dll) and the appropriate messages sent, logged and state variables set 39. Program flow then continues by determining the need for the Target PC 40 and/or the PCN White lists 42. It is worth noting that these White Lists can list Internet Protocol addresses that are allowed but can also specify times of allowed use and other security issues. Within the system that is defined by this invention, the ITO TCP Blocking DLL only concerns itself with the IP Address lists. Other White Lists are considered by other aspects of the Service Application defined by this invention. If White Lists are used, only Remote IP addresses specifically listed will be allowed for connections 51, if not the ITO TCP Blocking DLL will behave as if all Remote IP addresses are allowed. Continuing to element 44, the table of information listing all current TCP connections is requested via the iphlpapi.dll thru a call to function GetTcpTable. If an error is returned from this call 45, the error is posted and logged 46 and program flow continues at the beginning of the program loop 35. If no errors are encountered 45, the results within the returned connection table are processed by the loop beginning at element 47 and ending with element 54a. For each connection the state of the connection is determined 48. Not all states are necessary to address and thus are ignored and program execution proceeds at the beginning of the for loop at element 47 and the next connection is considered. Next the Remote IP address is determined 49 and if the connection IP is determined to be a local resource 50 that connection is skipped and processing continues with the next element in the for loop 47. Program flow continues to element 51 where the need to for White List comparisons is considered. If the local settings and state variables require such processing program flow control continues with element 52 where the current White Lists are queried for the existence of the specific connection IP Address, if the IP Address is found this is an Allowed connection and the event is logged and appropriate messages posted to indicate that the Allowed connection event occurred 53 with program execution continuing with the next connection vial element 47. If the White list is not being used 51 or the specific connection's remote IP is not within the utilized White List then the specific connection is blocked 54 with appropriate messages posted and event logged as a blocked connection. When all connections have been processed program flow continues to element 55 via element 54a, critical errors are checked and if present program termination occurs with appropriate messages posted, events logged, and resources released 56, otherwise program execution continues at the beginning of the program loop 35 via element 55a.

We claim:

1) Enables or disables a Target Personal Computer's IP based Internet connectivity (web browsing, IM, file sharing, IRC, etc.) based upon the presence or lack thereof of a Physical Control Device (PCN).

2) Target PC will keep track of allowed or disallowed PCNs to further discriminate behavior beyond what is listed in claim 1.

3) PCN will keep track of allowed or disallowed Target PCs to further discriminate behavior beyond what is listed in claim 1 and 2.

4) Alloyed IP addresses can be stored on both the target PC and PCN (white list) for purposes of further discriminating system behavior beyond what is listed in claims 1,2 and 3.

5) Calendar (date and Time) events can be considered in the decision process indicated to further discriminate system behavior beyond what is listed in claims 1-4. This is comprised of elements stored within a PCN and on a Target PC.

6) Multiple PCN levels are possible. At present there are 2. Administrative and User. An Administrative PCN acts as a portable authentication provider to both Target PCs and user PCNs. Administrative PCNs can modify and provide security rights to user PCNs and Target PC where appropriate security rights are present.

7) Security level hierarchy includes any combination of the following with events and comparisons weighted as need be to allow or disallow specific behavior. Target permitted PCNs (claim 2), PCN permitted Targets (claim 3), as well as PCNs permitting PCNs (claim 6).

8) User data stored on both PCN and Targets has limited access determined by security hierarchy described in claim 7. This behavior is unique in that a user level PCN cannot access or modify its own data without the required presence of various security comparators.

9) The total number of hours and positive event activity (claim 1) per interval is tracked by both the Target PCs and the PCNs. The data on the PCN is read only when various security comparators have been validated. As an example, this feature is used to limit the total number of hours of IP access per week, per day, or per month as defined necessary.

10) When used in conjunction with other Target PCs connected over an Internet, uniquely identified PCNs can be flagged for unique messaging. For example, emails tagged for a specific PCN's ID can only be received when the defined PCN is present.
